(19) United States
(12) Patent Application Publication
(10) Pub. No.: US 2005/0191052 A1
(43) Pub. Date: Sep. 1, 2005

(54) Optical emission module

(76) Inventor: Karl Schrodinger, Berlin (DE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 10/788,054

(22) Filed: Feb. 26, 2004

(51) Int. Cl. H04B 10/08

(52) U.S. Cl. 398/12

(57) ABSTRACT

The invention is related to an optical emission module having a particularly high degree of reliability. The emission module includes a redundant optical emission module having at least two emission elements and having a control device, which is connected to the at least two emission elements. According to the invention, in the emission mode, the control device respectively switches at least one of the emission elements to the active state and at least one of the other emission elements to the passive state.

The invention relates to an optical emission module, in particular for optical data transmission systems.

### OBJECT OF THE INVENTION

The invention is based on the object of specifying an optical emission module having a particularly high degree of failsafeness.

### SUMMARY OF THE INVENTION

Said object is achieved according to the invention by means of a redundant optical emission module having at least two emission elements and having a control device, which is connected to the at least two emission elements. According to the invention, in the emission mode, the control device respectively switches at least one of the emission elements to the active state and at least one of the other emission elements to the passive state.

A fundamental advantage of the optical emission module according to the invention is that it is particularly failsafe since there are at least two emission elements, at least one of which forms a “replacement emission element”. This means that, in the event of the active emission element failing, the replacement emission element can be put into operation instead of the failed emission element, with the result that the emission mode is maintained.

The control device preferably respectively switches off an active emission element and replaces it with one of the other previously passive emission elements if the active emission element is defective. The control device regards an active emission element as being defective, for example, when the latter exhibits an operating behavior lying outside a prescribed operating range.

The operating range of the emission elements is preferably prescribed individually for each emission element—that is to say is prescribed on an emission-element-individual basis.

The emission module may, for example, have a monitor device, which measures the optical emission power of the at least one active emission element and transmits a measurement signal (which indicates the respective emission power) to the control device. In such a case, the control device is preferably configured in such a manner that it ascertains the operating behavior of the active emission elements using the respective assigned measurement signal of the monitor device.

The control device may, for example, prescribe the operating current for each of the active emission elements by having recourse to a prescribed drive table or look-up table. In such a case, the control device switches over to one of the other emission elements if the optical emission power of one of the active emission elements undershoots a prescribed minimum optical emission power.

In this case, the control device may prescribe the operating current taking into account prescribed operating parameters which are contained in the look-up table (already mentioned). By way of example, the temperature of the emission elements may be taken into account as an operating parameter.

Alternatively, the control device may keep the optical emission power of the active emission elements constant by readjusting the operating current, said control device appropriately adjusting the operating current taking into account the measured values of the monitor device: deactivation of an emission element and switching over to one of the other emission elements are preferably effected when the operating current required for achieving a prescribed optical emission power exceeds or would exceed a prescribed maximum current.

The control device preferably has a memory, in which it stores which of the emission elements are defective and which are not. As already mentioned above, the control device may conceive as being defective those emission elements which previously exhibited an operating behavior lying outside a prescribed operating range and which were therefore switched off.

The memory is preferably configured in such a manner that it continues to store the memory data (which have been stored in it) even during a switched-off phase of the emission module. This has the advantage that, once the optical emission module has been switched on again, it is not necessary to recheck which emission elements are defective and which are operational; this is because the corresponding information may be retrieved from the memory. Accordingly, during operation of the emission module and/or once the emission module has been switched on again, the control device takes into account, for activation, only those emission elements which have not yet been stored in the memory as “defective”.

The monitor device may, for example, have a respective individually assigned monitor element for each emission element. Alternatively, the monitor device may have a single monitor element, which is optically connected to all the emission elements of the emission module.

The control device may, for example, have a control module and a switching device, which is connected to the control module. The switching device is then used, in a manner dependent on control signals of the control module, to switch on those emission elements which are intended to be activated.

The switching device may, for example, have a respective individual driver circuit for each emission element, it being possible for said driver circuit to be activated or switched off by means of the control signals of the control module.

Alternatively, the switching device may have at least one driver circuit, which is assigned, on the output side, to at least two emission elements. Switches which are switched on and off, respectively, by means of the control signals of the control module are preferably arranged between the driver circuit and the assigned emission elements. Driving the switches in an appropriate manner thus makes it possible to select the emission elements to be activated.

In order to ensure that persons cannot be harmed when using the emission module, the control device preferably has a laser safety circuit for the purpose of detecting impermissible states, said laser safety circuit being used to deactivate the emission elements in the case of an impermissible state or a hazardous state.

In order to transmit fault signals to an external system connected to the emission module, the control device preferably has a fault signal output interface for transmitting the fault signals.

Moreover, it is considered to be advantageous if the control device has a communication interface, by means of which the emission module can interchange data with other emission modules and moreover can be adjusted, for example.

The emission module is preferably configured in such a manner that it switches a respective emission element to the active state, or switches on the latter, and switches off all the other emission elements.

In addition, the invention relates to a method for operating an emission module.

In this regard, the invention provides for at least one of the emission elements of the emission module to be respectively switched to the active state and at least one of the other emission elements of the emission module to be switched to the passive state in the emission mode of the emission module.

In order to elucidate the invention:

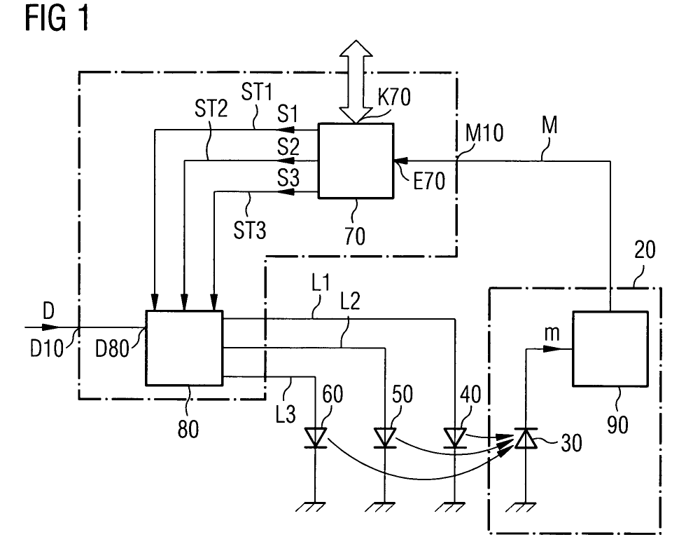

FIG. 1 shows a first exemplary embodiment of a redundant optical emission module according to the invention,

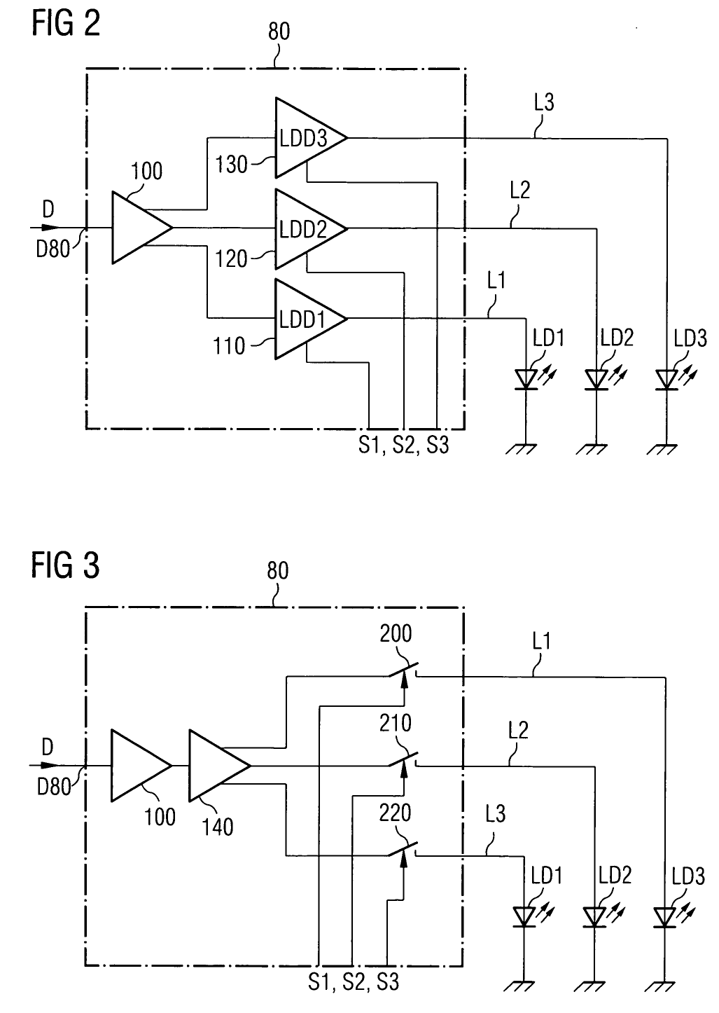

FIG. 2 shows a first exemplary embodiment of a switching device of a control device of the emission module shown in FIG. 1,

FIG. 3 shows a second exemplary embodiment of a switching device of the control device shown in FIG. 1,

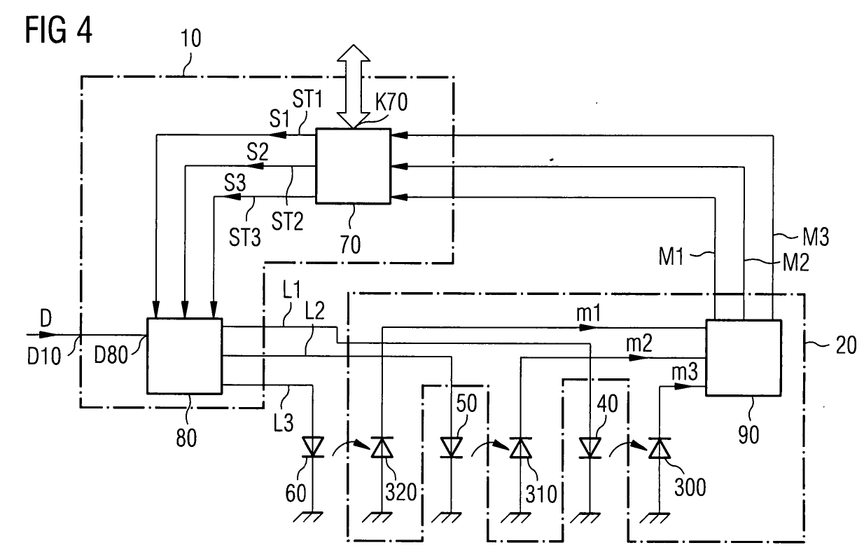

FIG. 4 shows a second exemplary embodiment of a redundant optical emission module according to the invention, and

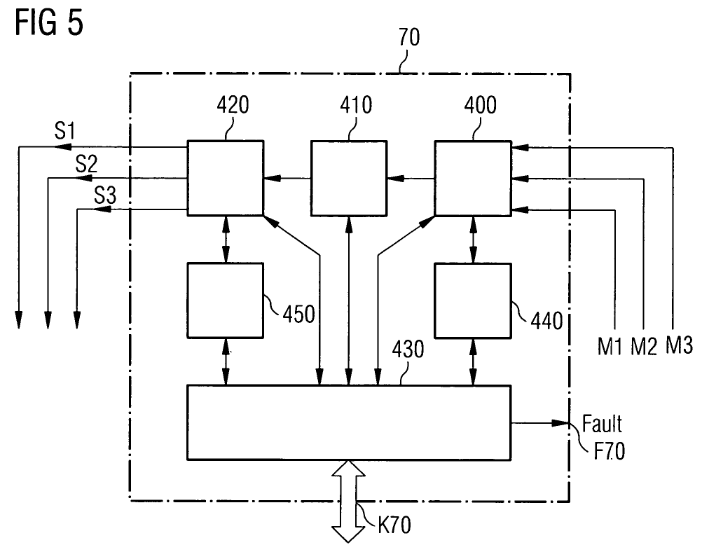

FIG. 5 shows an exemplary embodiment of a control module of the control device of the emission module shown in FIG. 1 or FIG. 4.

FIG. 1 shows a first exemplary embodiment of a redundant optical emission module. The emission module has a control device 10, which is connected to a monitor device 20 via a measurement input M10. The monitor device 20 comprises, inter alia, a monitor element 30, which is optically coupled to three emission elements 40, 50 and 60. The emission elements 40, 50 and 60 may, for example, be laser diodes or light-emitting diodes.

The control device 10 contains a control module 70, which is connected, by its input E70, to the measurement input M10 of the control device 10 and thus to the monitor device 20. A communication terminal K70 of the control module 70 forms a communication interface K10 of the control device 10.

The control module 70 is connected, on the output side, to a switching device 80 via three control lines ST1, ST2 and ST3.

The switching device 80 has a data input D80, which forms a data input D10 of the control device 10. Data signals D may be fed into the switching device 80 via the data input D10 or the data input D80 and, from said switching device, may be transmitted to the three emission elements 40, 50 and 60 via drive lines L1, L2 and L3.

The emission module shown in FIG. 1 is operated as follows:

When the emission module is put into operation for the first time, the control module 70 will first of all select one of the three emission elements 40, 50 or 60 for the emission mode. By way of example, the control module 70 selects the emission element 40 as the “first” emission element.

Accordingly, the control module 70 transmits a corresponding control signal S1 to the switching device 80 via the control line ST1, said switching device then switching the data signals D which are present at the data input D10 or D80 and are intended to be transmitted using the emission module shown in FIG. 1 through to the emission element 40 via the drive line L1. The data signals may be switched through, for example, by using the data signals D to modulate an operating current supplied by the control module 70 as the control signal S1. The emission element 40 will thus begin to emit the data D (present on the input side) as optical signals.

Some of the light generated by the emission element 40 is received by the monitor element 30 of the monitor device 20, whereupon the monitor element 30 generates a corresponding measurement current m and transmits it to a monitor amplifier 90 of the monitor device 20. The monitor amplifier 90 amplifies the measurement current m and forms therefrom an amplified measurement signal M, which passes to the measurement input M10 of the control device 10 and thus to the input E70 of the control module 70. The control module 70 can thus monitor the optical output power of the emission element 40.

If the control module 70 ascertains that the optical output power generated by the emission element 40 is too low or else that the operating current required to achieve the prescribed minimum optical emission power is too high, the control module 70 deduces therefrom that the emission element 40 is defective. In such a case, the control module 70 will switch off the emission element 40 and replace it with one of the two other emission elements 50 or 60. By way of example, the emission element 50 is activated instead of the emission element 40. Activation of this type is effected in such a manner that the control module 70 switches on the emission element 50 via the control line ST2, the switching device 80 and the drive line L2.

The third emission element 60 is activated in a corresponding manner if the second emission element 50 has failed.

The control module 70 preferably has a memory, in which it stores which of the three emission elements 40, 50 and 60 are defective and which are operational. That is to say, if the emission module is switched off in the meantime and is subsequently put into operation again, the control module 70 can ascertain, by interrogating its memory, which of the emission elements 40, 50 or 60 are no longer suitable for being put into operation since they are defective.

FIG. 2 illustrates a first exemplary embodiment of the switching device 80 shown in FIG. 1. The illustration reveals an input amplifier 100, the input of which forms the data input D80 of the switching device 80. On the output side, the input amplifier 100 is connected to three laser driver circuits 110, 120 and 130—referred to below as laser drivers for short—which can be switched on and off.

The three laser drivers are switched on or off by means of control signals S1, S2 and S3 which are transmitted by the control module 70 via the control lines ST1, ST2 and ST3. The control signals S1, S2 and S3 may thus be used to individually select and switch on the three emission elements 40, 50 and 60. By way of example, only one single emission element is respectively activated and the other emission elements are switched off. Alternatively, it is also possible to activate two of the three emission elements, in which case, if one of the active emission elements fails, it is replaced by the third, previously passive emission element.

FIG. 3 illustrates a second exemplary embodiment of the switching device 80 shown in FIG. 1. In contrast to the first exemplary embodiment shown in FIG. 2, the switching device 80 has only one single laser driver 140. This laser driver 140 is connected, on the output side, to three switches 200, 210 and 220. The switches 200, 210 and 220 may be formed, for example, by CMOS switches.

The three switches 200, 210 and 220 are directly activated by means of the control signals S1, S2 and S3 which are transmitted by the control module 70 via the control lines ST1, ST2 and ST3. The three switches 200, 210 and 220 therefore switch the emission elements 40, 50 or 60 (individually assigned to them) either on or off.

FIG. 4 shows a second exemplary embodiment of a redundant optical emission module according to the invention. In contrast to the emission module shown in FIG. 1, this emission module has a monitor device 20 containing three monitor elements 300, 310 and 320. The three monitor elements 300, 310 and 320 are respectively individually assigned to one of the three emission elements 40, 50 and 60. Each monitor element thus respectively measures solely the optical output power of the assigned emission element. Each monitor element generates a measurement current m1, m2 or m3, which is amplified and transmitted to the control module 90 (as amplified measurement signal M1, M2 or M3) by the monitor amplifier 90.

FIG. 5 illustrates an exemplary embodiment of the control module 70 shown in FIGS. 1 and 4. It can be seen that the control module 70 contains, on the input side, a selection module 400, which is connected to the monitor device 20. The function of the selection module 400 is to respectively select that measurement signal M1, M2 or M3 of the monitor device 20 which belongs to the respective emission element 40, 50 or 60, which has been selected or switched to the active state.

Moreover, the control module 70 has a regulator 410, which is downstream of the selection module 400, evaluates the measurement signal M1, M2 or M3 of the monitor device 20 and correspondingly sets the operating current for the respective emission element 40, 50 or 60, which has been switched to the active state.

Connected downstream of the regulator 410 is a second selection module 420, which transmits the operating current generated by the regulator 410 as control signal S1, S2 or S3 to the selected emission element 40, 50 or 60 via the respectively assigned control line ST1, ST2 or ST3. The first selection module 400, the regulator 410 and also the second selection module 420 are driven by a sequence control module 430, which may, for example, be a programmable microprocessor.

The sequence control module 430 is connected to the communication interface K70 of the control module 70. Moreover, the sequence control module 430 is connected to a fault signal output interface F70 of the control module 70. Fault signals can be read from the sequence control module 430 and thus from the control module 70 via said fault signal output interface F70.

FIG. 5 also reveals a threshold value switch, which is connected, on the one hand, to the sequence control module 430 and, on the other hand, to the selection module 400. The threshold value switch 440 evaluates the measurement signals M1, M2 and M3 of the monitor device 20 and generates a corresponding warning signal W for the sequence control module 430 if the measured value (of the monitor device 20) present at the selection module 400 undershoots a prescribed threshold value. Undershooting the threshold value prescribed in the threshold value switch 440 indicates that the respective active emission element 40, 50 or 60 is defective and must be replaced by another emission element.

When the warning signal W is present, the sequence control module 430 drives the regulator 410 and the second selection module 420 in such a manner that another emission element is activated.

FIG. 5 furthermore reveals a laser safety circuit 450, which cooperates with the sequence control module 430 and the second selection module 420. The function of the laser safety circuit 450 is to detect impermissible states and switch off the emission elements if a hazardous situation has occurred.

The control module 70 preferably additionally contains a memory, which can store data even without a power supply, for example an EEPROM memory module. In such a case, the control module 70 can store, during operation, which emission elements are defective; each time the emission module is switched on again after being taken out of operation, the selection module 430 will first of all read the memory in order to ascertain which of the emission elements are defective and which are not. The emission elements stored as defective are then not considered any further.

If, however, the control module 70 does not have a memory, in which defective emission elements can be stored, the control module 70 will proceed in a fixed sequence and will first of all activate the emission element 40, for example. If the latter is, in this case, a defective emission element, the control module 70 will successively test emission element after emission element to determine whether the respective emission element is working correctly or not. As soon as the control module 70 finds an operational emission element, it will activate the latter for the emission mode.

The control module 70 and the sequence control module 430 can also digitally store the operating points of the individual emission elements in a memory. In the case of systems having a control loop, the light power desired value of the light signal is stored, by way of example, for this purpose; in the case of controlled systems having a drive table (look-up table), the operating currents required for the respective operating point are stored in the look-up table, if appropriate even in a temperature-dependent manner.

In summary, the control module 70 shown in FIG. 5 thus performs the following functions:
The control module 70 controls the switch-on operation of the emission module.
The control module 70 detects defective or failed emission elements in the course of evaluating the measurement signals supplied by the monitor device on the input side.
The control module 70 switches over the emission elements if the respective active emission element has failed or is defective.
The control module 70 regulates and controls the operating currents of the emission elements.
The control module 70 stores the operating points of the emission elements.
The control module stores the operating states of the emission elements. This means that defective or expended emission elements are stored, so that they are no longer switched on in future.
The control module 70 emits a fault signal at the fault signal output interface. F70, said fault signal indicating all expended or defective lasers.
The control module 70 can be programmed via the communication interface K70 in such a manner that the emission elements can be adjusted both with respect to one another and with respect to emission elements of other emission modules.
The control module 70 carries out sequence control in order to adjust and program laser drivers contained in the downstream switching device 80.
The control module 70 deactivates all emission elements if the laser safety circuit 450 detects a hazardous situation.

For the sake of completeness, it should be mentioned that the selection module 400 in the control module 70 may be omitted if the monitor device 20 transmits only one single measurement signal M to the control device 10 (cf. FIG. 1); this is because it is not necessary in such a case to select various measurement signals.

For the rest, the temperature dependence of the monitor device 20 can be compensated for by means of the control module 70 if its temperature response is known or stored in the control module 70.

List of reference numerals

| | |
|---|---|
| 10 | Control device |
| 20 | Monitor device |
| 30 | Monitor element |
| 40 | Emission element |
| 50 | Emission element |
| 60 | Emission element |
| 70 | Control module |
| 80 | Switching device |
| 100 | Input amplifier |
| 110, 120, 130, 140 | Laser drivers |
| 200, 210, 220 | Switches |
| 300, 310, 320 | Monitor elements |
| 400 | Selection module |
| 410 | Regulator |
| 420 | Second selection module |
| 430 | Sequence control module |
| 440 | Threshold value switch |
| 450 | Laser safety circuit |
| ST1, ST2, ST3 | Control line |
| L1, L2, L3 | Drive line |
| M | Measurement signal |
| m | Measurement current |
| S1, S2, S3 | Control signal |

1. A redundant optical emission module comprising at least two emission elements and a control device, which is connected to the at least two emission elements and, in an emission mode of the emission module, respectively switches at least one of the emission elements to an active state and at least one of the other emission elements to a passive state.

2. The redundant optical emission module according to claim 1, wherein the control device respectively switches off the at least one active emission element and replaces it with one of the other previously passive emission elements if the at least one active emission element is defective.

3. The redundant optical emission module according to claim 2, wherein the control device respectively regards the at least one active emission element as being defective if the latter exhibits an operating behavior lying outside a prescribed operating range.

4. The redundant optical emission module according to claim 3, wherein the operating range is prescribed on an emission-element-individual basis.

5. The redundant optical emission module according to claim 1, wherein the emission module further comprises a monitor device, which measures an optical emission power of the at least one active emission element and transmits a measurement signal which is indicative of the respective emission power to the control device.

6. The redundant optical emission module according to claim 5, wherein the control device respectively ascertains an operating behavior of the at least one active emission element using the measurement signal of the monitor device.

7. The redundant optical emission module according to claim 6, wherein the control device controls an operating current of the at least one active emission element and switches over to one of the other emission elements if the optical emission power of the at least one active emission element undershoots a prescribed minimum optical emission power.

8. The redundant optical emission module according to claim 7, wherein the control device controls the operating current of the at least one active emission element taking into account prescribed operating parameters thereof.

9. The redundant optical emission module according to claim 8, wherein a temperature of the emission elements is taken into account as an operating parameter.

10. The redundant optical emission module according to claim 5, wherein the control device keeps the emission power of the at least one active emission element constant by readjusting the operating current of the at least one active emission element and switches over to one of the other emission elements if the operating current required for achieving the prescribed optical emission power exceeds a prescribed maximum current.

11. The redundant optical emission module according to claim 1, wherein the control device comprises a memory, in which it stores which of the emission elements are defective.

12. The redundant optical emission module according to claim 11, wherein the memory is configured in such a manner that it continues to store the memory data which have been stored therein even during a switched-off phase of the emission module.

13. The redundant optical emission module according to claim 12, wherein, during operation of the emission module and once the emission module has been switched on again, the control device takes into account, for activation, only those emission elements which have not been stored in the memory as defective.

14. The redundant optical emission module according to claim 5, wherein the monitor device comprises a respective individually assigned monitor element for each emission element.

15. The redundant optical emission module according to claim 5, wherein the monitor device comprises a monitor element, which is connected to all the emission elements of the emission module.

16. The redundant optical emission module according to claim 1, wherein the control device comprises a control module and a switching device, which is connected to the control module and, in a manner dependent on control signals of the control module, respectively switches on the at least one active emission element.

17. The redundant optical emission module according to claim 16, wherein the switching device comprises a respective driver circuit for each emission element, wherein each driver circuit is operable to be activated or switched off by means of the control signals of the control module.

18. The redundant optical emission module according to claim 16, wherein the switching device comprises at least one driver circuit, which is assigned, on an output side, to at least two emission elements, and a respective switch, which is switched on and off, respectively, by means of a control signal of the control module, being arranged between the driver circuit and the assigned emission elements.

19. The redundant optical emission module according to claim 1, wherein the control device comprises a laser safety circuit operable to detect impermissible states, said laser safety circuit being used to deactivate the emission elements in the case of an impermissible state.

20. The redundant optical emission module according to claim 1, wherein the control device comprises a fault signal output interface, which is used to transmit fault signals to an external system connected to the emission module.

21. The redundant optical emission module according to claim 1, wherein the control device comprises a communication interface, by means of which the emission module is adjusted with respect to other emission modules.

22. A method for operating a redundant optical emission module having at least two emission elements, comprising:
switching at least one of the emission elements to an active state; and
switching at least one of the other emission elements to a passive state in an emission mode of the emission module.

23. The method according to claim 22, further comprising switching off the at least one active emission element and replacing the at least one active emission element with one of the other previously passive emission elements if the at least one active emission element is defective.

24. The method according to claim 23, wherein the at least one active emission element is regarded as being defective if it exhibits an operating behavior lying outside a prescribed operating range.
